(19) United States
(12) Patent Application Publication
(10) Pub. No.: US 2022/0079114 A1
(43) Pub. Date: Mar. 17, 2022

(54) PET FOOD HOLDER

(71) Applicant: Chia-Sheng LAI, Taipei City (TW)

(72) Inventor: Chia-Sheng LAI, Taipei City (TW)

(21) Appl. No.: 17/022,071

(22) Filed: Sep. 15, 2020

(51) Int. Cl. A01K 5/01

(52) U.S. Cl. CPC A01K 5/0114

(57) ABSTRACT

A pet food holder has a base, an annular protrusion, at least one through hole, and at least one bottom recess. The annular protrusion protrudes up from a top surface of the base. The at least one through hole is formed through the base and is surrounded by the annular protrusion. The at least one bottom recess is formed in a bottom surface of the base. Each of the at least one bottom recess corresponds in position to and communicates with a corresponding one of the at least one through hole. The pet food holder is used for embedding a piece of pet food on the pet food holder. With the pet food holder for embedding the pet food, a pet is able to experience different textures and does not get bored while biting and chewing the pet food holder and the pet food.

### BACKGROUND OF THE INVENTION

### 1. Field of the Invention

The present invention relates to a pet toy, especially to a pet food holder that is used for embedding pet food on the pet food holder.

### 2. Description of the Prior Art(s)

Pet toys, such as chew toys, tug toys, squeaky toys, and plush toys, are designed to allow pets to chase after, play with, bite or chew for purposes of stimulation and relief from boredom. Particularly, chewing stimulates saliva enzymes and is helpful in preventing plaque buildup on teeth and gum disease, and a dog chewing on a dog bone is less inclined to excessively scratch or lick his paws.

A kind of conventional chew toy is made entirely of inedible materials such as rubber, plastic, latex, cloth or the like. Another kind of conventional chew toy is made entirely of edible materials and may rawhide or manufactured bones such as nylabones and dental bones. However, textures of the conventional chew toys are monotonously elastic or hard. Therefore, pets get bored easily.

To overcome the shortcomings, the present invention provides a pet food holder to mitigate or obviate the aforementioned problems.

### SUMMARY OF THE INVENTION

The main objective of the present invention is to provide a pet food holder that has a base, an annular protrusion, and at least one through hole. The annular protrusion is formed on and protrudes up from a top surface of the base and enclosing an upper recess. The at least one through hole is formed through the top surface and a bottom surface of the base and is surrounded by the annular protrusion.

Preferably, the pet food holder further has at least one bottom recess. The at least one bottom recess is formed in the bottom surface of the base. Each of the at least one bottom recess corresponds in position to and communicates with a corresponding one of the at least one through hole. A diameter of each of the at least one bottom recess is greater than A diameter of the corresponding one of the at least one through hole.

The pet food holder is used for embedding a piece of pet food on the pet food holder. With the pet food holder for embedding the pet food, a pet is able to experience different textures and does not get bored while biting and chewing the pet food holder and the pet food.

Other objectives, advantages and novel features of the invention will become more apparent from the following detailed description when taken in conjunction with the accompanying drawings.

### BRIEF DESCRIPTION OF THE DRAWINGS

FIG. 1 is a top perspective view of a first preferred embodiment of a pet food holder in accordance with the present invention;

FIG. 2 is a bottom perspective view of the pet food holder in FIG. 1;

FIG. 3 is an operational top perspective view of the pet food holder in

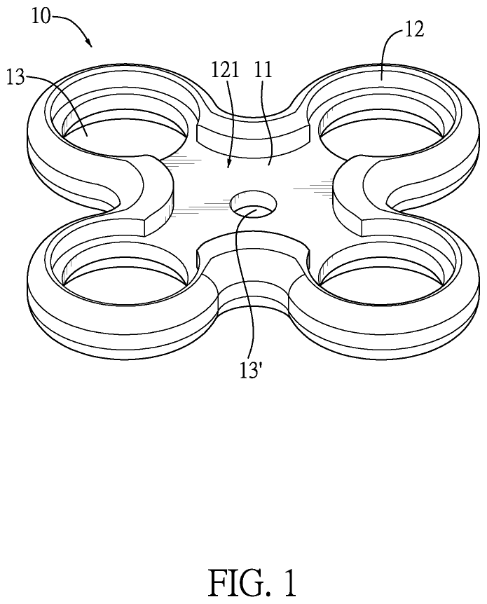

FIG. 1;

FIG. 4 is an operational cross-sectional side view of the pet food holder in FIG. 1;

FIG. 5 is another operational cross-sectional side view of the pet food holder in FIG. 1;

FIG. 6 is a top perspective view of a second preferred embodiment of a pet food holder in accordance with the present invention;

FIG. 7 is a bottom perspective view of the pet food holder in FIG. 6; and

FIG. 8 is an operational cross-sectional side view of the pet food holder in FIG. 6.

### DETAILED DESCRIPTION OF THE PREFERRED EMBODIMENTS

With reference to FIGS. 1 and 4, a pet food holder 10, 10A in accordance with the present invention comprises a base 11, 11A, an annular protrusion 12, 12A, at least one through hole 13, 13′, 13A, and at least one bottom recess 14, 14′, 14A.

The base 11, 11A has a top surface and a bottom surface.

With further reference to FIGS. 4 and 8, the annular protrusion 12, 12A is formed on and protrudes up from the top surface of the base 11, 11A and encloses an upper recess 121, 121A. The upper recess 121, 121A is defined above the top surface of the base 11, 11A.

The at least one through hole 13, 13′, 13A is formed through the top surface and the bottom surface of the base 11, 11A and is surrounded by the annular protrusion 12, 12A. Each of the at least one through hole 13, 13′, 13A is defined by an annular edge.

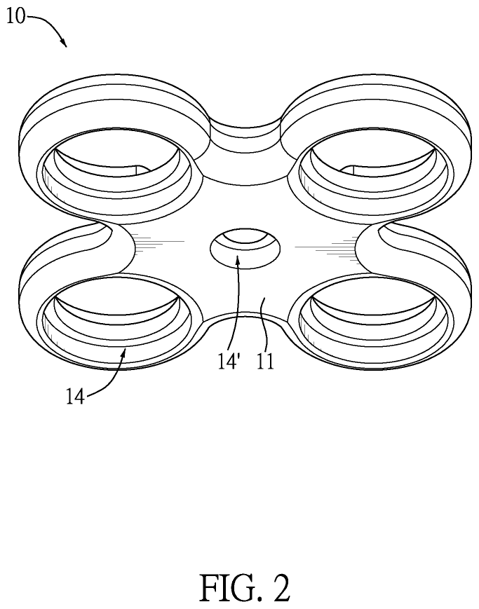

With further reference to FIGS. 2 and 5, the at least one bottom recess 14, 14′, 14A is formed in the bottom surface of the base 11, 11A. Each of the at least one bottom recess 14, 14′, 14A corresponds in position to and communicates with a corresponding one of the at least one through hole 13, 13′, 13A.

With further reference to FIGS. 4, 5 and 8, a diameter D1, D1A of each of the at least one bottom recess 14, 14′, 14A is greater than a diameter D2, D2A of the corresponding one of the at least one through hole 13, 13′, 13A. Thus, the annular edge of each of the at least one through hole 13, 13′, 13A is formed as a flange and protrudes between the upper recess 121, 121A and the corresponding one of the at least one bottom recess 14, 14′, 14A.

In the preferred embodiments, each of the at least one bottom recess 14, 14′, 14A is concentric with the corresponding one of the at least one through hole 13, 13′, 13A.

As shown in FIGS. 1 and 2, in a first preferred embodiment, the at least one through hole 13, 13′ includes multiple through holes 13, 13′, and the at least one bottom recess 14, 14′ includes multiple through holes 14, 14′ accordingly.

As shown in FIGS. 6 and 7, in a second preferred embodiment, the at least one through hole 13A includes one through holes 13A, and the at least one bottom recess 14A includes five through holes 14A accordingly.

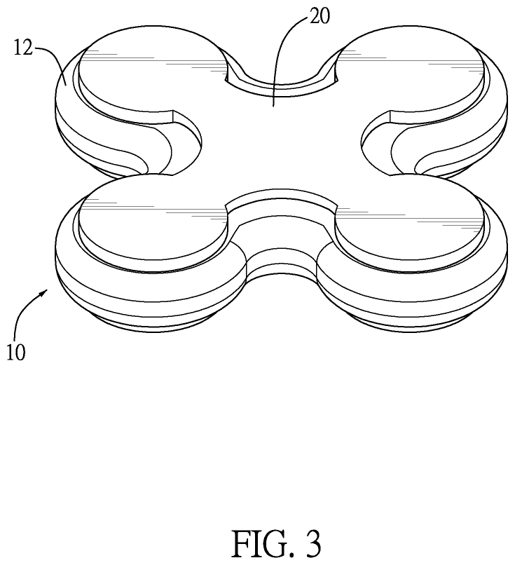

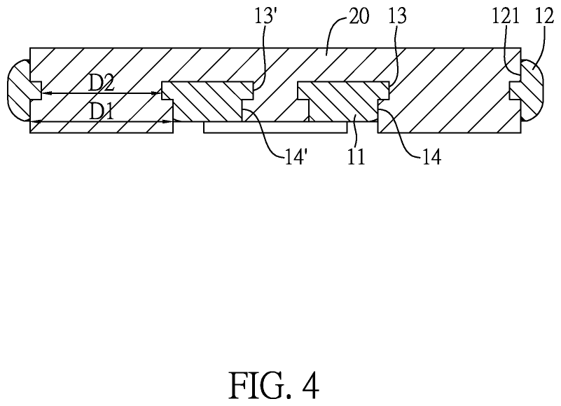

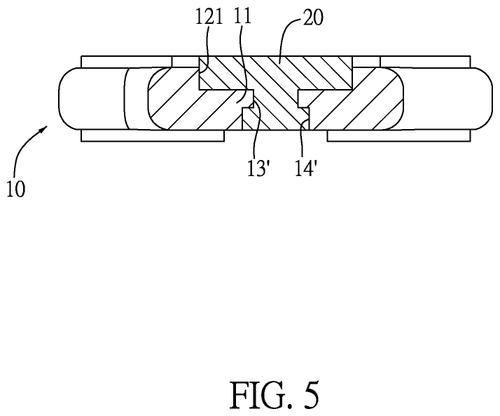

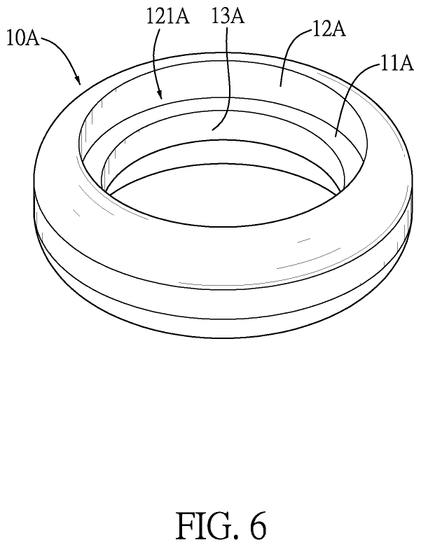

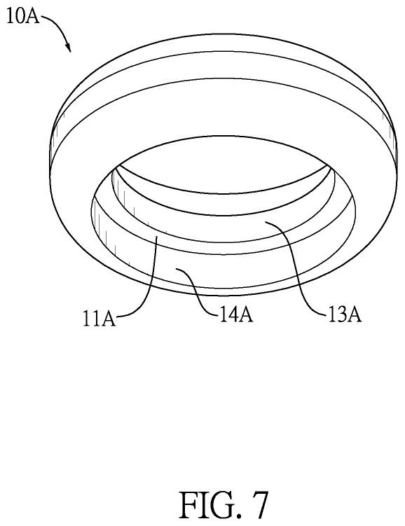

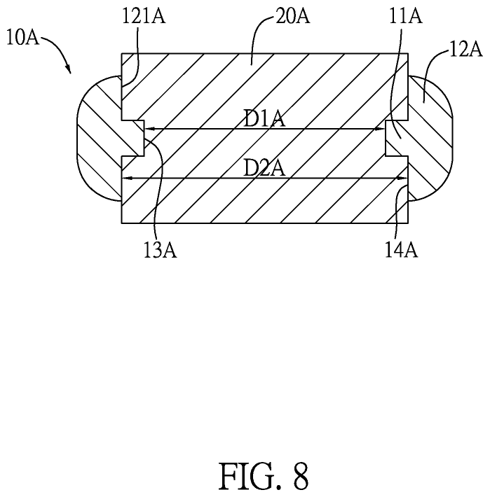

As shown in FIGS. 3 to 5 and 8, a piece of pet food 20, 20A may be embedded in the upper recess 121, 121A, the at least one through hole 13, 13′, 13A and the at least one bottom recess 14, 14′, 14A of the pet food holder 10, 10A. The flange-like annular edge defined around the at least one through hole 13, 13′, 13A engages in the pet food 20, 20A to securely hold the pet food 20, 20A in the pet food holder 10, 10A.

The pet food holder 10, 10A is used for embedding the piece of pet food 20, 20A thereon. The pet food holder 10, 10A and the pet food 20, 20A are made of materials of different hardness. Thus, with the pet food holder 10, 10A for embedding the pet food 20, 20A, a pet is able to experience different textures and does not get bored while biting and chewing the pet food holder 10, 10A with the piece of pet food 20, 20A.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pet food holder comprising:
a base;
an annular protrusion formed on and protruding up from a top surface of the base and enclosing an upper recess; and
at least one through hole formed through the base and surrounded by the annular protrusion.

2. The pet food holder as claimed in claim 1, wherein
the pet food holder further comprises at least one bottom recess, the at least one bottom recess is formed in a bottom surface of the base, and each of the at least one bottom recess corresponds in position to and communicates with a corresponding one of the at least one through hole; and
a diameter of each of the at least one bottom recess is greater than a diameter of the corresponding one of the at least one through hole.

3. The pet food holder as claimed in claim 2, wherein each of the at least one bottom recess is concentric with the corresponding one of the at least one through hole.

4. The pet food holder as claimed in claim 2, wherein
the at least one through hole includes multiple through holes; and
the at least one bottom recess includes multiple through holes.

5. The pet food holder as claimed in claim 2, wherein
the at least one through hole includes one through hole; and
the at least one bottom recess includes one through hole.
